(19) United States
(12) Patent Application Publication
(10) Pub. No.: US 2005/0272008 A1
(43) Pub. Date: Dec. 8, 2005

(54) Dental prosthetic reinforced with zirconia ceramic

(76) Inventor: Larry Stites, Tracy, CA (US)

Correspondence Address: CHOATE, HALL & STEWART LLP, TWO INTERNATIONAL PLACE, BOSTON, MA, 02110, US

(21) Appl. No.: 11/062,522

(22) Filed: Feb. 22, 2005

Related U.S. Application Data
(60) Provisional application No. 60/546,349, filed on Feb. 20, 2004.

(51) Int. Cl. A61C 13/12

(52) U.S. Cl. 433/180

(57) ABSTRACT

A dental prosthetic comprising at least one unit for attachment to a tooth and a ceramic structural component that is embedded in a trough on the lingual surface of the at least one unit. The ceramic comprises zirconia.

This application claims the priority of U.S. Provisional Application No. 60/546,349, filed Feb. 20, 2004, the entire contents of which are incorporated by reference herein.

### FIELD OF THE INVENTION

This invention concerns an improved dental prosthetic reinforced with a bar formed from a zirconia-containing ceramic.

### BACKGROUND OF THE INVENTION

A dental bridge is a device for the restoration and replacement of one or more natural teeth. It replaces at least one missing tooth and is supported on either side by the remaining teeth. A bridge generally comprises a pontic for replacement of the missing tooth, and connectors which connects the pontic to a retaining member, such as a crown formed on an abutment tooth adjacent the pontic. A dental bridge typically must be aesthetic, as well as strong, in order to withstand forces generated by mastication of various types of foods and to maintain the positions of the abutting teeth. Prior art bridges therefore often incorporate a structural reinforcing element to provide strength, such as a metal pontic rod or a fiber-reinforced polymer support, and a veneer to provide aesthetics, including ceramic or particulate-filled resin composite veneers.

However, bridges reinforced with metal rods fail to offer optimum aesthetic. In addition, prior art bridges featuring particulate-filled resin composite veneers can experience fracture of the veneer under tensile loading, due to a low strain-to-failure values of the composites. Veneers that are unsupported (due to poor framework design) are also vulnerable to shear under occlusal/incisal loading. Thus, there still remains a need for dental bridges which are aesthetically pleasing and which possess sufficient structural integrity to withstand the stresses associated with mastication.

### SUMMARY OF THE INVENTION

In one aspect, the invention is a dental prosthetic comprising at least one unit for attachment to a tooth and a ceramic structural component that is embedded in a trough on the lingual surface of the at least one unit. The ceramic includes zirconia. For example, the ceramic may include stabilized zirconia or zirconia-toughened alumina. Zirconia may be stabilized with yttria, MgO, CaO, ceria, or an oxide of a rare earth element. The prosthetic may replace a single tooth or a plurality of teeth, or it may attach to one or more teeth, or it may accomplish some combination of these. The unit may be a veneer, onlay, crown, or pontic, and the prosthetic may be a veneer, onlay, crown, or bridge.

The prosthetic may further include a composite disposed about at least a portion of the structural component in the trough. The composite includes an inorganic filler and a polymer resin and may also include a pigment, a stabilizer, or both. The inorganic filler may include one or more of barium aluminum silicate, barium oxide, lithium aluminum silicate, strontium, lanthanum, tantalum, glass, quartz, silica, fused silica, colloidal silica, alumina, zirconia, and tin oxide. The polymer resin may include a polymer of 2-hydroxyethyl methacrylate (HEMA), ethylene glycol dimethacrylate (EGDMA), diethyleneglycol dimethacrylate (DEGDMA), triethylene glycol dimethacrylate (TEGDMA), tetrahydrofurftiryl methacrylate, trimethylolpropane trimethacrylate (TMPTMA), analogous acrylates or methacrylates, 2,2-bis[4(2-hydroxy-3-methacryloxypropoxy)phenyl]propane (bis-GMA), urethane dimethacrylate (UDMA), diphenyl sulfone dimethacrylate, or polytetramethyleneglycol dimethacrylate (PTMGDMA).

In another aspect, the invention is a dental bridge for replacing one or more missing teeth between two abutment teeth. The bridge includes two attachment units, e.g., crowns, onlays and veneers, that will attach to one abutment tooth and the other attachment unit will attach to the other abutment tooth, one or more pontic, and a structural component that is embedded in a trough on the lingual surface of attachment units and the one or more pontics. The structural component is formed from a ceramic including zirconia.

When a patient is missing several adjacent teeth or portions thereof, a prosthetic may be sufficiently strong to withstand the forces of mastication. The structural component of the dental prosthetic of the invention provides prostheses such as bridges with good structural integrity, making it particularly useful for patients who are missing several adjacent teeth.

### BRIEF DESCRIPTION OF THE DRAWING

The invention is described with reference to the several figures of the drawing, in which,

FIG. 1 is an image of a master model of a portion of a mouth for use in preparing a prosthetic according to an embodiment of the invention.

FIG. 2 is an image of the master model of FIG. 1 as viewed from the labial side of the teeth.

FIG. 3 is an image of a sprued wax model of a prosthetic according to an embodiment of the invention.

FIG. 4 is an image of a porcelain prosthetic for use with an embodiment of the invention.

FIG. 5 is an image of a groove cut in the lingual surface of a prosthetic for use with an embodiment of the invention.

FIG. 6 is an image of wax placed in the groove shown in FIG. 5 to model a zirconia ceramic bar according to an embodiment of the invention.

FIG. 7 is an image of a zirconia ceramic bar for reinforcing a prosthetic according to an embodiment of the invention.

FIG. 8 is an image of the zirconia ceramic bar of FIG. 7 inserted into a prosthetic according to an embodiment of the invention.

FIG. 9 is an image of a prosthetic with a zirconia ceramic bar inserted across the prosthetic and a composite material disposed over the bar according to an embodiment of the invention.

### DETAILED DESCRIPTION OF CERTAIN PREFERRED EMBODIMENTS OF THE INVENTION

In one embodiment, the invention is a dental prosthetic comprising at least one unit for attachment to a tooth and a ceramic structural component that is embedded in a trough on the lingual surface of the at least one unit. The ceramic comprises zirconia. The techniques of the invention may be applied to dental restorations produced using any commercially available pressable system, including but not limited to Empress, available from Ivoclar Vivadent, Optimal Pressable Ceramics, available from Jeneric/Pentron, Authentic, available from Vita Zahnfabrik, Finesse, available from Dentsply, and Procera, available from Nobel Biocare.

The dental prosthetic may be a prosthetic for an entire tooth or several teeth or for part of a tooth or part of several adjacent teeth. For example, the prosthetic may be a veneer, onlay, crown, or bridge. Alternatively or in addition, the prosthetic may include a plurality of units such as veneers, crowns, bridges, and pontics. For example, a bridge includes a pontic that replaces a patient's missing tooth or teeth and units such as veneers and crowns to attach the pontic to the teeth adjacent to the pontic. In one embodiment, a reinforcing bar or structural component is embedded in a trough in the lingual side of the prosthetic. Where the prosthetic includes several units, e.g., a bridge, a single structural unit may extend across all the units of the prosthetic.

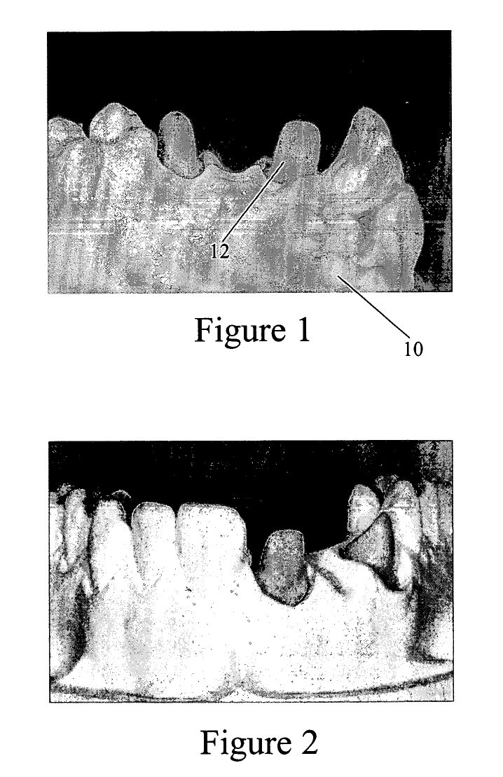

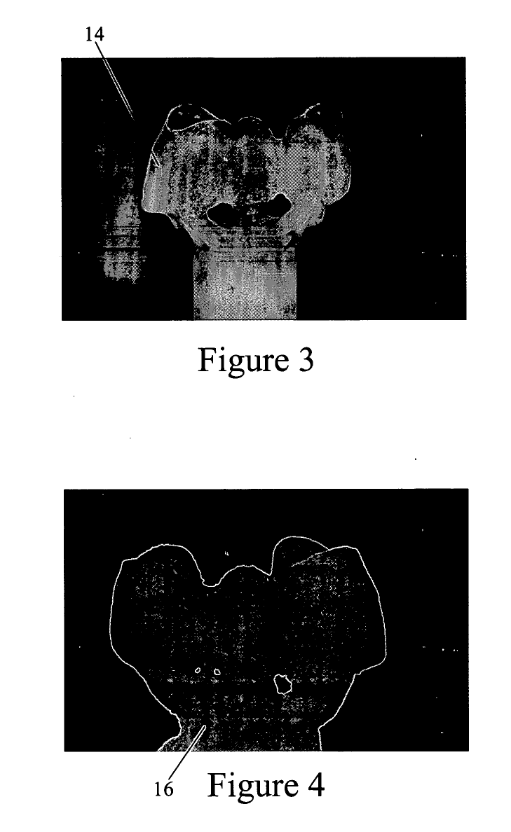

Dental prosthetics may be made by any method known to those skilled in the art. In one embodiment, the prosthetic is made by a lost wax process. A master model 10 is made of the patient's mouth or a portion of the mouth after preparation of the teeth that will receive the prosthetic (FIGS. 1, 2). For example, the dentist may make an impression of the patient's mouth, which is then used to prepare the model. In some embodiments, the portion of the model that corresponds to the teeth that will receive the prosthetic may be fabricated from a different material than the remainder of the model. For example, the bulk of the model may be formed from plaster, while die stone preparation 12 models the teeth. A wax model of the prosthetic is then formed on the master model. The wax-up 14 is sprued (FIG. 3) and invested with any commercial investment material. In many instances, a particular supplier will provide an investment material that it feels is appropriate for use with its own porcelain composition from which the prosthetic is made. The investment plaster hardens to form a mold which is heated up to burn out the wax pattern from the inside of the mold. A porcelain or other glass-ceramic ingot may then be pressed into the cavity of the mold, thus duplicating the original wax original pattern in ceramic and forming the prosthetic. The prosthetic 16 is devested, for example, with aluminum oxide (FIG. 4) and a diamond disc is used to remove the prosthetic from the sprues. The prosthetic may then be stained, glazed, and otherwise aesthetically prepared.

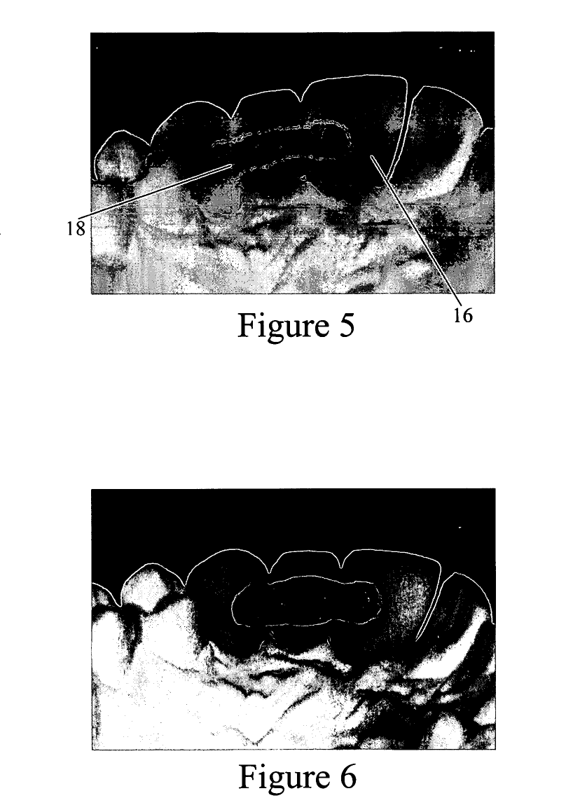

Once all the prosthetic units (e.g., crowns that will be attached to the teeth abutting a bridge and pontics that will replace the missing teeth) have been prepared, they are placed on the master model and aligned as they will be when the prosthetic is completed (FIG. 5). A diamond bur or other suitable tool is used to cut a trough 18 on the lingual surface of the units such that when the units are positioned as they will be in the completed prosthetic, the trough cut in each unit will extend across the lingual surface approximately parallel to the incisal edge of the unit and will be aligned from unit to unit to form a continuous band. Thus, the trough will extend across the entire lingual surface of the prosthetic connecting all of the restoration units. In one embodiment, the trough is about 1.5 mm deep. The width of the trough is not critical and will depend, for example, on the size of the patient's mouth. Of course, when the prosthetic only includes a single unit, there are no adjacent units to consider, and the trough only extends across the single unit.

Wax is applied to the trough of the aligned units such that the wax completely fills in the trough and creates a continuous bar of wax that extends across the lingual surface of the aligned units (FIG. 6). The wax bar is removed from the trough and is used as a model to create a ceramic bar 20 that will be used to connect all units together in the prosthetic. The ceramic may have sufficient stiffness and fracture toughness to withstand the forces imposed during mastication. Exemplary ceramics appropriate for use with the invention include stabilized zirconias, for example, those stabilized with yttria, ceria, magnesium oxide, calcium oxide, and oxides of various rare earth metals, and zirconia-toughened alumina.

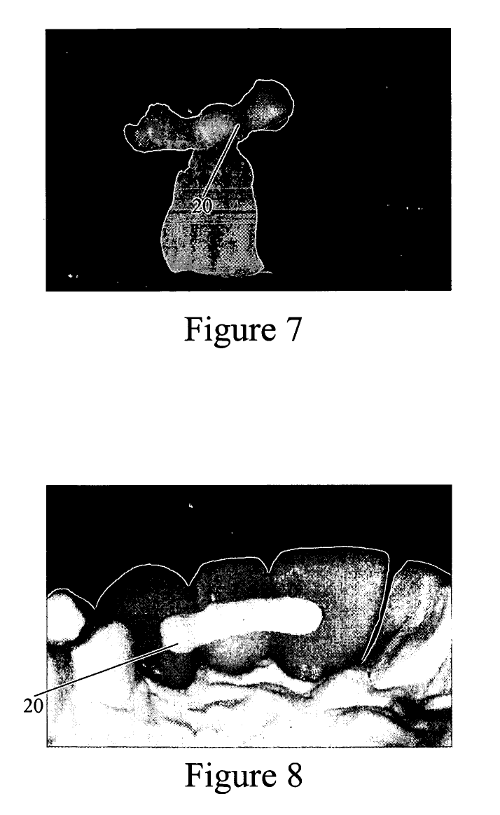

The wax model of the bar is scanned and a copy of the bar is milled out of a partially sintered ceramic block (FIG. 7). The shape and contour of the ceramic bar may be adjusted by grinding or milling at this stage since the partially sintered material has a chalk-like consistency. The bar is then sintered. For example, an yttria-stabilized zirconia bar may be sintered at about 1350° C. for about 6 hrs.

With all units in place, the ceramic bar is inserted into the trough on the lingual side of the units and checked for proper fit (FIG. 8). The ceramic bar can be adjusted using a diamond bur or other abrasive known to those skilled in the art until the correct fit is achieved.

In preparation for bonding the ceramic bar in place, the ceramic prosthetic is etched using 5% HF etching gel for one minute. The prosthetic is then rinsed and air dried. The ceramic bar is sandblasted, then steam cleaned. The ceramic bar is bonded into place in the trough with, any adhesive appropriate for use in dentistry, for example, Maxcem™, available from Kerr Dentistry.

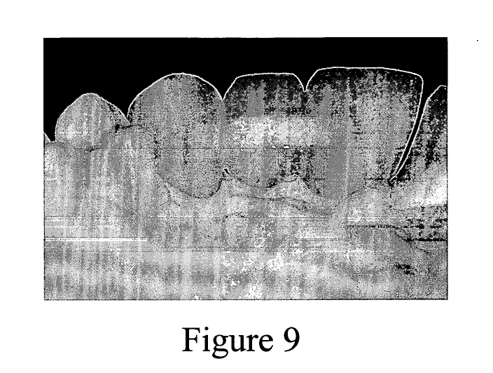

After the ceramic bar is bonded in place, a composite is placed over the ceramic bar in the trough to provide a smooth surface to the lingual side of the prosthetic (FIG. 9). The composite is added and cured following the manufacturer's instructions, then finished and polished. The type of composite material used is not critical. In one embodiment, the composite is cured with light and/or heat and comprises a resin and at least one inorganic filler. In addition, the composite may include a polymerization reaction initiator to initiate light cure, an amine accelerator, at least one thermal catalyst to initiate thermal cure, pigments as needed for coloration, and/or stabilizers. Suitable components of the resin include at least one reactive methacrylate functionalized monomer or oligomer, selected from the group comprising 2-hydroxyethyl methacrylate (HEMA), ethylene glycol dimethacrylate (EGDMA), diethyleneglycol dimethacrylate (DEGDMA), triethylene glycol dimethacrylate (TEGDMA), tetrahydrofurftiryl methacrylate, trimethylolpropane trimethacrylate (TMPTMA), analogous acrylates or methacrylates, 2,2-bis[4(2-hydroxy-3-methacryloxypropoxy)phenyl]propane (bis-GMA), urethane dimethacrylate (UDMA), diphenyl sulfone dimethacrylate, and similarly functionalized monomers or oligomers.

Monomers and oligomers disclosed in Qian et al., U.S. Pat. No. 5,658,963, may be used in the present invention, and are incorporated by reference herein. The monomer also may be polytetramethyleneglycol dimethacrylate (PTMGDMA) and similar materials of varying molecular weight. One skilled in the art will recognize that any resin that is suitable for use in dentistry may be employed for use with the invention.

Suitable inorganic fillers for use in the composites may include at least one, for example, mixtures of two to four of the following: barium aluminum silicate, barium oxide, lithium aluminum silicate, strontium, lanthanum, tantalum, glass, quartz, silica, fused silica, colloidal silica, alumina, zirconia, tin oxide, and the like. The fillers may be silanated to facilitate bonding with the components of the resin. One skilled in the art will recognize that any filler appropriate for use with composites that are used in dentistry. Filler particle size may vary from 0.005 to 15 microns in diameter, for example, from 0.01 to 13 microns.

### Equivalents

Those skilled in the art will recognize, or be able to ascertain using no more than routine experimentation, many equivalents to the specific embodiments of the invention described herein. The scope of the present invention is not intended to be limited to the above Description, but rather is as set forth in the following claims.

1. A dental prosthetic comprising:
at least one unit for attachment to a tooth; and
a ceramic structural component that is embedded in a trough on the lingual surface of the at least one unit, wherein the ceramic comprises zirconia.

2. The dental prosthetic of claim 1, wherein the ceramic comprises stabilized zirconia or zirconia-toughened alumina.

3. The dental prosthetic of claim 2, wherein the stabilized zirconia is yttria-stabilized zirconia, MgO-stabilized zirconia, CaO-stabilized zirconia, ceria-stabilized zirconia, or zirconia stabilized with an oxide of a rare earth element.

4. The dental prosthetic of claim 1, wherein the prosthetic replaces a single tooth, replaces a plurality of teeth, attaches to a single tooth, attaches to a plurality of teeth, or any combination of the above.

5. The dental prosthetic of claim 1, wherein the unit is a veneer, onlay, crown, or pontic.

6. The dental prosthetic of claim 1, wherein the prosthetic is a veneer, onlay, crown, or bridge.

7. The dental prosthetic of claim 1, further comprising a composite disposed about at least a portion of the structural component in the trough, the composite comprising an inorganic filler and a polymer resin.

8. The dental prosthetic of claim 7, wherein the composite further includes a pigment, a stabilizer, or both.

9. The dental prosthetic of claim 7, wherein the inorganic filler comprises one or more of barium aluminum silicate, barium oxide, lithium aluminum silicate, strontium, lanthanum, tantalum, glass, quartz, silica, fused silica, colloidal silica, alumina, zirconia, and tin oxide.

10. The dental prosthetic of claim 7, wherein the polymer resin comprises a polymer of 2-hydroxyethyl methacrylate (HEMA), ethylene glycol dimethacrylate (EGDMA), diethyleneglycol dimethacrylate (DEGDMA), triethylene glycol dimethacrylate (TEGDMA), tetrahydrofurftiryl methacrylate, trimethylolpropane trimethacrylate (TMPTMA), analogous acrylates or methacrylates, 2,2-bis[4(2-hydroxy-3-methacryloxypropoxy)phenyl]propane (bis-GMA), urethane dimethacrylate (UDMA), diphenyl sulfone dimethacrylate, or polytetramethyleneglycol dimethacrylate (PTMGDMA).

11. A dental bridge for replacing one or more missing teeth between two abutment teeth, comprising:
two attachment units selected from crowns, onlays and veneers, wherein one attachment unit will attach to one abutment tooth and the other attachment unit will attach to the other abutment tooth;
one or more pontic; and
a structural component that is embedded in a trough on the lingual surface of attachment units and the one or more pontics, wherein the structural component is formed from a ceramic comprising zirconia.
